(19) United States
(12) Patent Application Publication
(10) Pub. No.: US 2003/0148806 A1
(43) Pub. Date: Aug. 7, 2003

(54) Method and apparatus for optimizing game design and development upon multiple game systems

(76) Inventor: Steven A. Weiss, Henderson, NV (US)

Correspondence Address: ROY A. EKSTRAND, STE 150, 3158 REDHILL AVE., COSTA MESA, CA, 92626, US

(21) Appl. No.: 10/071,996

(22) Filed: Feb. 7, 2002

(51) Int. Cl. A63F 13/00

(52) U.S. Cl. 463/20

(57) ABSTRACT

A method and apparatus for optimizing game design and development upon multiple gaming systems includes an authoring system in which a set of authoring tools and game components are provided to an authoring computer. The authoring computer operates under the control of a game designer to produce a set of game design files which define a game to be played upon a gaming device such as a slot machine. A collector transforms the game design files into ordered game data files which may then be transferred to a host gaming device. A game data player and interface are provided within the host gaming device. The game data player in response to the game data files provides a sequence of interpretive instruction commands which are communicated to and which interpretive sequence the game play of the host game play device. The use of the game data collector and game data player facilitate gaming authority approval and provide great flexibility allowing any game data player equipped host gaming device to play any game data collected game without adaptation or alteration.

### FIELD OF THE INVENTION

This invention relates generally to gaming devices and particularly to methods and apparatus for the creation, operation and installation of games upon multiple gaming devices. The invention further relates to methods and apparatus for providing a more effective and efficient game design and method of deployment which greatly streamlines the creation, approval and operation of gaming devices.

### BACKGROUND OF THE INVENTION

Gaming devices are well known in the art and have, for the most part, steadily increased in both complexity and capability. One of the most pervasive types of gaming devices is known generally in the art as the “slot machine”. The most popular early slot machines were mechanical devices fabricated as devices in which a plurality of reels each having an outer rim supporting a plurality of visual symbols and/or numbers were rotatably supported within a machine housing and viewable through a front window. A pull lever operated by the player and a gear drive and spring release mechanism coupled thereto rotated the reels at high speed and thereafter released the reels allowing them to slow and eventually stop. In most mechanical machines, a positional detent mechanism was operated upon each reel to ensure that the reels each stopped rotation within one of a predetermined plurality of rotational alignments or positions. The game results were defined or characterized by the combination of symbols aligned and viewable through the frontal window.

With the introduction and rapid advances of computer and electronic technologies, many functions and improvements were added to basic mechanical slot machines. As a result, slot machines evolved into three basic types characterized as mechanical, video or hybrid computer driven devices. Today each employs random number generation and computer control of rotating reels to generally mimic mechanical slot machines. As the infusion of electronic and computer technologies into gaming devices continued, increasing numbers of slot machines became largely computer driven video display gaming devices which, for the most part, simulated and enhanced a conventional slot machine gaming operation.

In addition, slot machines which play card games such as poker and blackjack as well as other creative games have been developed. The overall result of this technology infusion, has been the creation of modern slot machines in which the heart of the gaming device is a computer driven game processor and random number generator operating in accordance with a software game program or “script”. The processor operates under the game script to execute game play and determine game result.

Despite the relative simplicity of basic computer driven slot machines, the continuing competition among slot machine manufactures has resulted in substantial increases in complexity of the gaming devices. Particular attention and sophistication has been directed to the elegant video display graphics and special effects such as audio effects or the like. Further, the need for increased flexibility and capability in handling various methods in wagering and payout have correspondingly increased the complexity of the currency handling apparatus of the typical modern slot machine. The latter usually includes coin acceptors, currency bill validators, wagering computation and credit accumulation systems as well as payout functions and crediting systems. All of this sophistication combines to increase the complexity and cost of current slot machine gaming devices.

At present, slot machines are developed by practitioner's in the art in a process in which the devices are “hard coded” by highly skilled computer programmers. This hard coding manufacturing process is characterized by the creation of complete software systems within the slot machine platform which are capable of playing a specific game choreography. Typically, the computer software is particular to and specifically for a given game platform or device. Because this development process is performed by such highly skilled and highly paid computer programmers and other professionals, the resulting game development and manufacturing process is extremely costly.

Faced with the increasing cost and complexity of slot machine development, practitioner's in the art have attempted to increase the efficiency of game development and manufacture. One such attempt endeavors to separate the audio/visual game data from the game code itself. The objective of this approach is the creation of multiple variations of games using a common mathematical characteristic. This would have the advantage of allowing game developers to change various theme elements (for example, image appearance) without the involvement of highly paid and highly skilled computer programmers. Additionally, practitioner's have attempted to employ an “asset librarian” program which enables game designers to compile the audio/visual game assets, test the game software, compile the assets into a data file and thereafter load the collected data into the game. This creates the added efficiency of asset verification while protecting the game code from accidental corruption.

While these attempts at improving efficiency have the potential for being effective, they are nonetheless unable to facilitate the sufficient development of new game choreographies. Further, the foregoing attempts at efficiency improvement continue to require a computer programmer or team of programmers to implement the code creation. Because the resulting code remains machine specific, not withstanding the separation of data and game play code, the resulting game is not portable to another game platform.

In addition to the high costs and complexity of gaming machine manufacture, the government regulatory process further increases the time, difficulty and costs of game development and manufacture. The approval process utilized by gaming regulators is extremely time consuming and often difficult further adding to the overall cost of gaming machine development and manufacture. Gaming regulators require that the manufacturer submit each slot machine for inspection and approval prior to any manufacture or distribution of the machine. Thereafter, gaming regulators monitor the manufacturing process of approved slot machines with random inspection, and testing conducted within the manufacture's facility. Additionally, the manufacture of gaming devices may only be carried forward by licensed manufacturers having completed the licensing process.

In the event that a manufacturer wishes to introduce a new game, or even a slight variation of an approved game, the new or improved game must, once again, be submitted together with its game platform to the regulatory authority for the full model approval process. The use of a standardized game platform does not short-cut the approval process when a new game is implemented thereon. Within casinos operating slot machines and other gaming devices, gaming regulators routinely conduct regular inspections, validations and testing of approved slot machines operating on the casino floor. Because of the regulatory requirements, casino operators routinely move entire slot machines and replace them with new machines having different games operative thereon rather than simply swapping game software. If the gaming devices are made by different manufactures, or in some cases simply different models, it is not possible to move software between them. This process represents a substantial effort by casino operators and is inherently inefficient and costly.

Practitioners in the gaming arts have further attempted to meet these problems while concurrently attempting to improve the effective use of developing technology. For example, U.S. Pat. No. 6,071,190 issued to Steven A. Weiss et al. sets forth a GAMING DEVICE SECURITY SYSTEM APPARATUS AND METHOD in which a gaming device includes two processing areas linked together and communicating critical gaming functions via a security protocol wherein each transmitted gaming function includes a specific encrypted signature to be decoded and validated before being processed by either processing area. The two processing areas include a first processing area having a dynamic RAM and an open architecture design which is expandable without interfering or accessing critical gaming functions and a second “secure” processing area having a non-alterable memory for the storage of critical gaming functions therein.

In another system now within the market, the critical game element processor and the open architecture system are isolated functionally, but not physically. This system utilizes an operating system and interface to the critical game element processor by which the open architecture makes calls to critical game processor.

In a still further variation of gaming generally related to gaming devices, players participate using the internet. The relevant element to this gaming practice is found in the separation of gaming functions which must, of necessity, be utilized in such gaming.

Despite such efforts, however, there arises a continuing need in the art for generally improved and more efficient gaming devices and systems employed thereon. More particularly, there arises a continuing need in the art for more flexible methods and apparatus which facilitate and optimize game design and development to provide less cumbersome regulatory approval and to provide for game use on multiple gaming systems.

### SUMMARY OF THE INVENTION

Accordingly, it is a general object of the present invention to provide an improved method and apparatus for game design and development. It is a more particular object of the present invention to provide an improved method and apparatus for game design and game development which optimizes the efficiency and capabilities of the resulting game apparatus. It is a still more particular object of the present invention to provide an improved method and apparatus for game design and development which facilitates the creation of games and game systems operable upon multiple types of gaming apparatus. It is a still more particular object of the present invention to provide an improved method and apparatus for game design and development which enhances and expedites the approval process for gaming regulators and thereby improves the manufacturing and development efficiencies and economies of gaming machine manufacturers and developers.

In accordance with the present invention there is provided a gaming apparatus comprising: a gaming device having game playing means; a data player coupled to the gaming device; a data collector forming a plurality of data files defining a game; and an authoring system responsive to game designer inputs to form game files used by the data collector in forming the plurality of data files, the data files being transferred from the data collector to the data player and the data player producing a set of instruction commands from the data files for causing the gaming device to play the game.

Additionally, the present invention provides a gaming apparatus comprising: a game authoring system forming game design files defining an game; a data collector coupled to the authoring system compiling the game design files into data files; a gaming device; and a data player coupled to and controlling the gaming device, the data player receiving the data files and converting the data files to a set of commands operative upon the gaming device to play the game.

Further, the present invention provides a method of producing game apparatus comprising the steps of: designing a set of game files defining a game; compiling the set of game files to form a set of data files; transferring the set of data files to a data player; forming an instruction table using the data player in response to the data files; and operating a gaming device under the control of the data player using the instruction table to provide sequential commands for the gaming device.

From a still further perspective, the present invention provides a method of producing game apparatus comprising the steps of: designing a plurality of game design file sets each defining one of a plurality of games; compiling each of the sets of game design files to form a plurality of game data file sets; providing a gaming device; providing a data player coupled to the gaming device; forming an instruction table, using the data player in response to a selected one of the game data file sets; and operating the gaming device under control of the data player using the instruction table to provide sequential commands for the gaming device to play the game corresponding to the selected one of the game data file sets, the data player and the plurality of game data file sets being compatible such that each of the game data file sets may be used by the data player to play the games corresponding thereto.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a generalized block diagram of a method and apparatus for optimizing game design and development upon multiple gaming systems together with representative typical gaming devices;

FIG. 2 sets forth a more detailed block diagram of the present invention method and apparatus for optimizing game design and development upon multiple gaming systems;

FIGS. 3A and 3B taken together set forth a flow diagram depicting the operation of the authoring system of the present invention method and apparatus;

FIG. 4 sets forth a flow diagram depicting the operation of the game data collector of the present invention method and apparatus;

FIGS. 5A and 5B taken together set forth a flow diagram of the game simulator of the present invention method and apparatus;

FIGS. 6A and 6B taken together set forth a flow diagram of the operation of the game data player of the present invention method and apparatus.

### DESCRIPTION OF THE PREFERRED EMBODIMENTS

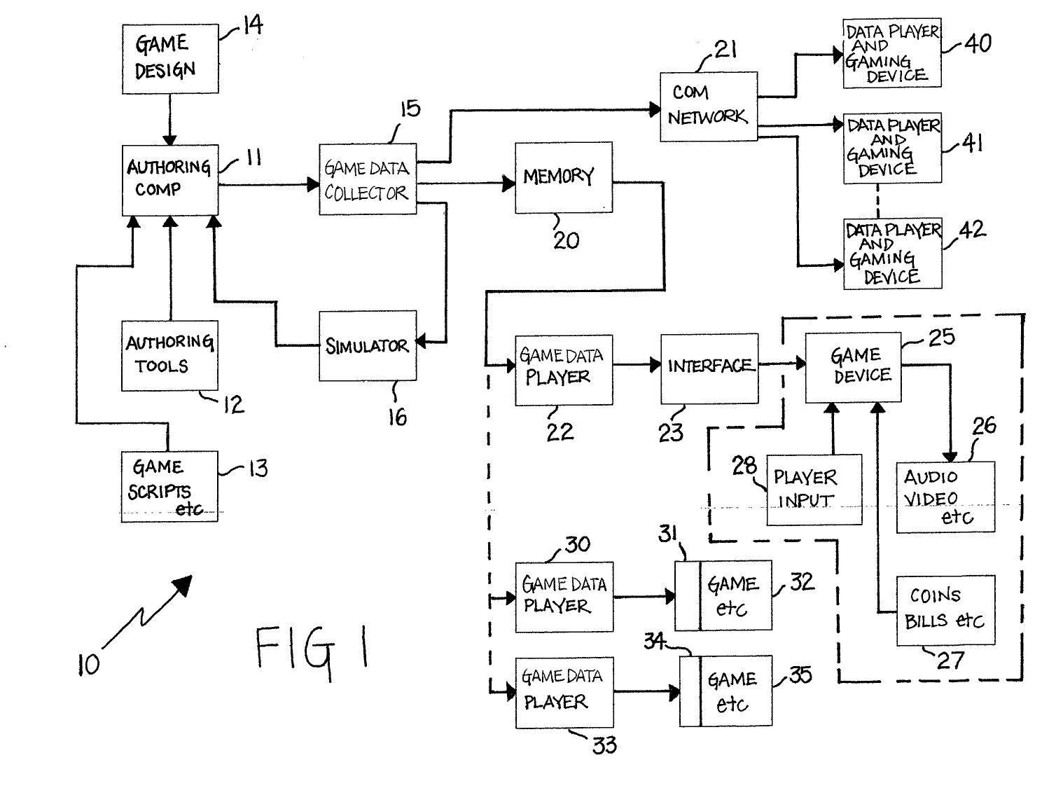

FIG. 1 sets forth a generalized block diagram of the present invention apparatus for game design and deployment generally referenced by numeral 10 together with a communication network and plurality of gaming devices operative in accordance with the anticipated use of the present invention apparatus and method. By way of overview, the basic approach of the present invention method and apparatus includes the employment of an authoring system which allows the game designer to carry forward game design in a substantially “artistic” environment and operation while avoiding the need for involvement by computer programmers. Accordingly, the authoring system allows a creative and artistic game designer to utilize a conventional personal computer together with authoring tools and software to design a game without resort to programming in machine language. The resulting game design files are then complied by a game data collector to provide files which then are transportable by any conventional method to a corresponding game data player resident within a conventional game device such as a slot machine or the like. The exchange of files between the game data collector and the game data player transfers a set of instructions to the game data player which then controls the operation of the slot machine. In accordance with an important aspect of the present invention, the use of a game data collector and game data player combination facilitates interchangeability between different approved game data collected games and between different approved game data player equipped gaming devices or slot machines without the need of individual approval by regulatory authorities once the overall concept is approved by regulatory authorities.

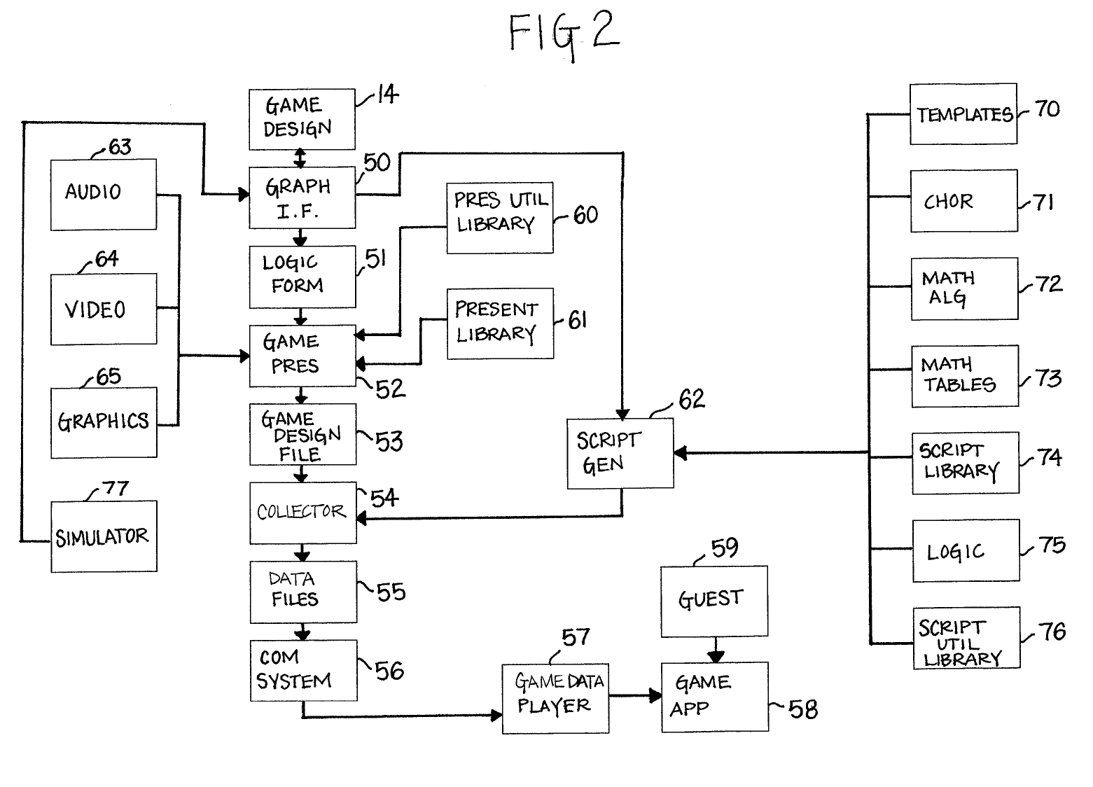

More specifically, apparatus 10 includes an authoring computer 11 which, may for example, be a conventional personal computer having an associated memory and having input capability such as a conventional keyboard and mouse for communicating inputs from a game designer 14. A set of authoring tools which comprise a software program 12 is operatively coupled to authoring computer 11. Further, a plurality of additional game design tools such as those set forth below in FIG. 2, such as game scripts and the like generally referenced by numeral 13 are also operatively coupled to authoring computer 11. The output of authoring computer 11 comprises a set of game design files which are coupled to a game data collector 15. Game data collector 15 converts the game design files to a corresponding set of game data files which are then transferred to a communication network 21 and/or a suitable memory 20. Memory 20 may comprise virtually any conventional memory devices such as a CD, Magnetic disk, tape or the like. Communication network 21 comprises a conventional communication apparatus such as a local area network within a casino or the like.

A first gaming device 24 includes a game device platform 25 constructed in accordance with conventional fabrication techniques, an operative in combination with conventional audio/video apparatus 26. Gaming device 24 further includes conventional coin and bill apparatus for currency input 27 together with a conventional player input apparatus 28. In accordance with the present invention, game device 24 further includes a game data player 22 coupled to an interface 23. Interface 23 is operatively coupled to game device platform 25. For purpose of illustrating an important advantage of the present invention method and apparatus, a second game device 32 having a second game data player 30 and interface 31 operatively coupled in the same fashion is also shown. An indeterminate number of it additional game devices each having respective game data players and respective interfaces is represented by gaming device 35 together with game data player 33 and interface 34.

Communication network 21 which, as mentioned, may for example, comprise a local area network within a casino, a wide area network between multiple casinos or multiple gaming jurisdictions, or the like, is shown operatively in communication with a plurality of gaming devices 40, 41 and 42 each of which will be understood to include a gaming device platform together with an associated game data player and interface in the manner shown by gaming device 24 together with game data player 22 and interface 23.

In operation, game designer 14 utilizes authoring computer 11 to employ authoring tools software 12 and game scripts etc. 13 to design a desired game. Of importance with respect to the present invention, is the aspect that game designer 14 need only be an artistic or creative game designer and need not have extensive computing and programming skills. The authoring tools of the present invention system enable the creative game designer to operate in a menu driven environment to select the various script, graphics, audio clips and video clips to be utilized in the game being designed. Additionally, the game designer is able to select the remaining game elements in a continuing menu driven environment such as templates, choreographies, mathematical algorithm and math tables.

As game designer 14 works through the menu driven operation of authoring computer 11 to produce a game design, a number of selections are made which form a game design file set. In accordance with the preferred fabrication of the present invention, authoring computer 11 facilitates the storage of a game design file set to allow the game designer to utilize the game design files in the creation of subsequent game improvements or modifications. In further addition, authoring computer 11 utilizing authoring tools 12 constructs a profile of preferences exercised by game designer 14 which allow authoring computer 11 to more efficiently serve the needs of each particular game designer.

Once the desired game design has been created, authoring computer 11 transfers the game design files to game data collector 15. Game data collector 15 converts the game design files to a set of instructions which correspond to each operation required by a game platform in playing the newly designed game. In addition, game data collector 15 performs data compression in accordance with a selected conventional data compression algorithm. Game data collector 15 further adds security and validation code to the instruction set which facilitate authentication and validation of the resulting game data files produced by collector 15 to enable the playing of the game upon a game data player equipped gaming device. The data within the game data files may be coded such that small segments of code represent larger, more complicated code portions or instructions. This method, often referred to as “tokenizing”, allows game data collector 15 to preprocess the game script and to parse the game text into tokens.

The resulting game data files may be transferred to game data equipped gaming devices in the form of fixed memory 20 and/or electronic communication network 21. Communication network 21 may, for example, as mentioned above comprise a local area network within a given casino or group of casinos. However, it will be recognized, that communication network 21 may comprise virtually any electronic file transfer network with the objective being the successful transfer of the game data files for the newly designed game to one or more of a plurality of gaming devices such as devices 40, 41 and 42 through electronic transfer.

The transfer of memory 20 to a given game data player equipped game such as gaming device 24 is carried forward by transferring memory 20 to a selected game data player such as game data player 22. This transfer may utilize virtually any mechanism for transferring files between a memory and player 22. Within game data 22, the game data files are authenticated and validated using the security code embedded by collector 15 and thereafter formed into a game play instruction file set. Interface 23 facilitates the communication between the processor of game device 25 and the output of game data player 22.

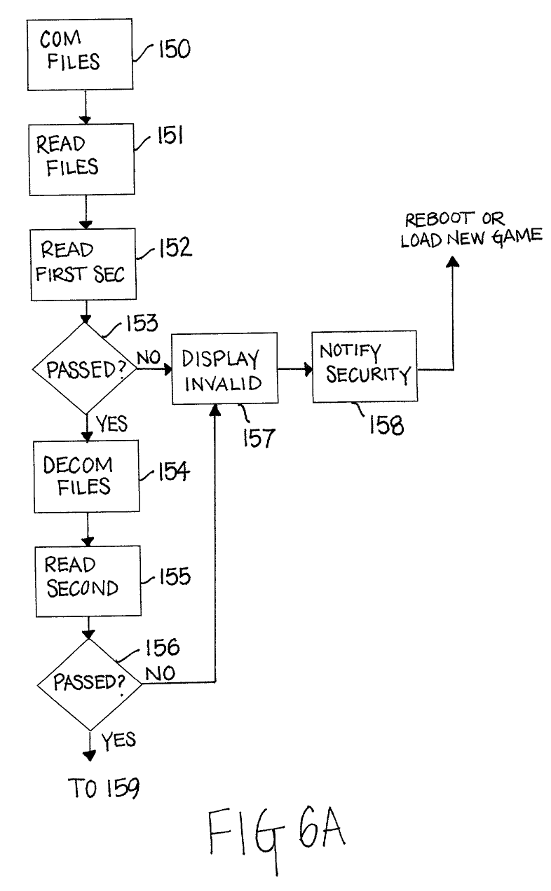

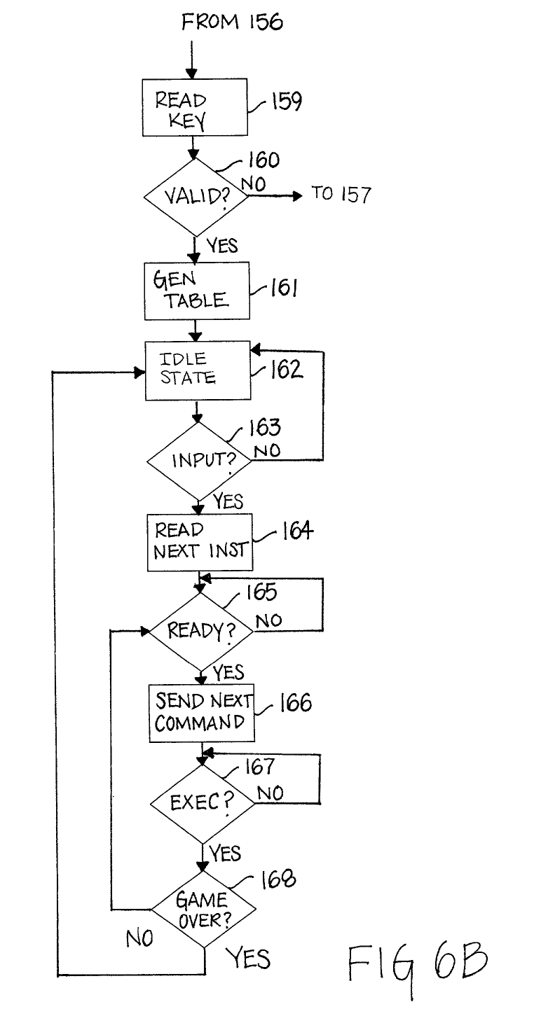

Once the game data files have been transferred to game data player 22, the game play operation set forth below in FIGS. 6A and 6B is carried forward. Suffice it to note here that game data player 22 presents a sequence of game play instructions which control the operation of gaming device 24. The transfer of memory 20 to additional game data player equipped gaming devices is carried forward in the same manner. Thus, in accordance with an important aspect of the present invention, the game data files produced by game data collector 15 may be utilized in a number of gaming devices having been equipped with a game data player.

In accordance with a further advantage of the present invention, the game designer is able to utilize a game play simulator 16 operatively coupled to the output of game data collector 15 to simulate game play upon a game data player equipped gaming device. Thus, simulator 16 utilizes the game data game files and mimics the operation of a gaming device in cooperation with authoring computer 11. This allows the game designer to view the “finished product”.

In accordance with an important aspect of the present invention, the flexibility of the game design and development process is greatly enhanced by the ability of any game data player equipped gaming device to play any game which has been authored on the authoring system of the inventive apparatus and which has been complied by a game data compiler. As a result, the flexibility available to gaming device manufactures is significantly improved by the capability of transferring any desired game data authored game to any game data player equipped game platform. The need previously existing for hard coded individual game programs for each game platform is no longer required. A similar advantage is enjoyed by a casino operator as the casino operator is able to utilize any game data collected game upon any slot machine or combination of machines in a simple file transfer. Thus, a casino operator may, for example, choose to seasonally vary the games played upon the various slot machines within the casino without having to physically move the slot machines about. Additionally, the casino operator need not be concerned about having slot machines produced by different manufactures due to the compatibility of game data collected games in operation with game data player equipped slot machines despite different manufactures. As a result, a casino operator is able to employ a much more flexible and highly effective disposition and distribution of games upon the various slot machines within the casino.

The present invention method and apparatus also streamlines and optimizes the game and machine approval process by government regulators. In a typical scenario, the game manufacturer submits a game data player equipped gaming device having a game data complied game operative thereon to gaming regulators for approval. Once the regulators have approved a submitted gaming device and game, each newly created game design authored by the present invention apparatus may be submitted directly for approval without being limited to a particular gaming device. Conversely, each gaming device equipped with a game data player and interface may be approved independently without limitation to a particular resident game.

By way of example, the creation of ten new games and ten new slot machines each created and fabricated in accordance with the present invention will require a total of twenty approvals (ten game approvals and ten gaming device approvals) because each game data produced game is compatible with and useable upon any game data player equipped gaming device, a total of one hundred combinations of games and slot machines is produced giving the casino operator substantial flexibility. Utilizing present technology, each combination of game and gaming device must be individually approved by gaming regulators. As a result, the example of ten games and ten slot machines described above would, using current technology, require one hundred approval processes rather than the twenty utilizing the present invention technology once the present invention concept is approved by regulatory authorities. As a result, a substantial reduction of the time and difficulty associated with regulatory approval is achieved by the present invention system.

FIG. 2 sets forth a more detailed block diagram of the present invention method and apparatus of game design and creation. Thus, a game designer 14 representing an artistic and creative person utilizes a conventional personal computer and the present invention authoring system via a graphical user interface 50 to design the visual, mechanical movement, sound, graphics and logic aspects of the desired game presentation. It will be apparent to those skilled in the art that the present invention method and apparatus applies with great advantage to gaming devices which are mechanical, video or hybrid (mechanical and computer driven). Graphical user interface 50 provides a “user friendly” means of communicating with the present invention authoring system. The interfaces based upon an interactive philosophy in which software is designed and written to solicit and series of responses from game designer 14 which are used to provide the structure and flow of the desired game. The objective of interface 50 is to maximize the freedom and creativity of game designer 14 without imposing a requirement that the user understand computer programming, terminology or architecture.

Basic script creation helps the designer create a game choreography. In general, a script defines one or more game play elements such as a rolling numbered ball or a moving card. A game choreography will typically include a substantial number of scripts or scripted elements. In accordance with an important aspect of the present invention method and apparatus described below, a plurality of game scripts and script elements are stored in a script library (Script Library 74 seen in FIG. 2). These stored scripts may be used and reused in forming game choreographies without the need of recreating scripts each time. In addition, graphical user interface 50 is configured to gather the preferences and style of game designer 14 during the game design process. The preferences and style of game designer 14 are then utilized to bring software modules together in a predetermined fashion combining the history of previous games designed by game designer 14. In addition, the preferences and “style” of a given designer may be stored to improve the efficiency of the game designer in subsequent use. As a result, game designer 14 is able to focus upon differences and enhancements of each newly designed game rather than reconstructing each new game from the start. As game designer 14 continues to interact with the present invention system via graphical user interface 50, a sophisticated history will be established further enabling game designer 14 to quickly and efficiently design and produce games. Graphical user interface 50 also communicates with game simulator 77 allowing game designer 14 to review game performance. In accordance with an important aspect of the present invention, game designer 14 will not need programming or extensive computer skills but need only be capable of interacting with the software of graphical user interface 50 to design and simulate a new game.

Graphical interface 50 cooperates with a logic formulator 51 which is a software program relying upon the logic details from the software of interface 50. Logic formulator 51 creates the instructions that establish the flow of the game being designed. In essence, this software generates the main program for game operation.

Game presentation generator 52 includes a computer software program which extracts files from a number of sources and components to establish modules which are utilized by logic formulator 51. These modules are used in the formulation of the game under design and, in addition, are stored in a presentation library 61 for use in future game designs. The information extracted by game presentation generator 52 result from cooperation with a number of sources including audio library 63, video library 64 and graphics library 65. In addition, a presentation utility library 60 together with presentation library 61 are operatively coupled to game presentation generator 52. The functions of each are described below in greater detail. However, suffice it to note here that these sources provide the desired audio, video, and graphic components used by game presentation generator 52.

More specifically, presentation utilities library 60 comprises a grouping of general purpose sub-routines utilized by game presentation generator 52 together with all supporting programs which manage, manipulate and distribute media clips. Presentation library 61 comprises a grouping of fully assembled visual and sound representations. These representations have been previously generated by game presentation generator 52 and have been stored for future use. Thus, game presentation generator 52 is able to access these stored files and apply them to a new game. This produces substantial reduction in the amount of work required by game designer 14. Modifications of these stored files are created by game presentation generator 52 and thereafter stored as new visual and sound representations within presentation library 61.

Audio library 63, video library 64 and graphics library 65 represent respective collections of sound clips, video clips and graphics for use by game presentation generator 52 in forming a game. They are in essence, organized memories within which these various clips have been stored.

Game design file 53 comprises an assembly of all components required to make up the presentation attributes of a completed game. This file contains every element that guest player 59 (the slot machine player) will see and hear during the entertainment experience of game play. Game design file 53 is coupled to a game data collector 54.

A script generator 62 is also operatively coupled to game data collector 54 and comprises a computer program fabricated to collect and integrate all of the operational data and logic of the various physical devices operating within the game system together with all associated mathematics. Script generator 62 operates in response to various inputs supplied by game designer 14 to graphical user interface 50. Script generator 62 utilizes a plurality of information and component sources in assembling the operational data and logic to be utilized by the physical devices of the game system. Thus, a collection of templates 70 is operatively coupled to script generator 62. The templates within collection 70 are each specific representations of physical device operational data and logic together with associated mathematics utilized in a particular gaming apparatus such as a particular slot machine. Various existing templates are stored within templates collections 70 and may be utilized if the game under design is to be run upon an existing specific gaming apparatus such as a slot machine. In the event a new here-to-fore used gaming apparatus is to be employed in the game under design, script generator 62 under the control of the responses provided by game designer 14 to graphical user interface 50 constructs and assembles the selected elements and generates new templates which represent that new gaming apparatus. In addition to current use, each new collection of templates is stored in template collection 70 for future use.

In a similar fashion, a collection of choreographies 71 are stored and maintained for selection by script generator 62 based upon user input to graphical user interface 50. These choreographies are specific representations of logic and data flow for a particular gaming apparatus such as a slot machine. In further similarity, a collection of math algorithms 72 provide math algorithms selected by script generator 62 based upon game designer input via graphical user interface 50. Each math algorithm is a specific set of mathematics for a particular gaming apparatus such as a slot machine.

In similar fashion, a collection of math tables 73 is maintained and operatively coupled to script generator 72. Math tables comprise specific sets of tables which support the math algorithms for a particular gaming apparatus such as a slot machine and are selected by script generator 62 in response to game designer input.

A script library 74 provides a collection of general game scripts which may be accessed by script generator 62. The purpose of the general scripts within script library 74 includes assisting the game designer in any unique tasks selected. A collection of logic routines 75 is also operatively coupled to script generator 62 providing a plurality of software routines which may be integrated into the game software to accomplish specific operational flow as defined by game designer 14. A script utilities library 76 contains a variety of “housekeeping” subroutines which are required by script generator 62 in preparing files and data elements which conform to formats and specifications as required by collector 54.

The outputs of game design file 53 and script generator 62 are both operatively supplied to a collector 54. Collector 54 is referred to herein as a game data collector in that it combines the game design files from game design file 53 with the script files produced by script generator 62 to produce game data files 55. Game data files comprise a sequence of game instructions which control the operation of a game data player equipped game apparatus to carry forward the designed game. Game data collector 54 further provides a variety of security and validation codes together with security encryption codes to combine with the game design files and script to form a complete set of game data files. In addition, collector 54 performs a data compression upon the encrypted and security protected game and script files. The basic format of the game data game files is, as mentioned above, an instruction format which is utilized by a game data player 57 in the manner set forth below in FIGS. 6A and 6B to control and operate a gaming device 58. Gaming device 58 is operative in response to the various game play inputs of a guest 59.

A communication system 56 is operative in transferring the completed game data files to a selected game data player for use by a game apparatus. As mentioned above, communication system 56 may comprise virtually any of the well known methods utilized in distributing computer files. Thus, communication system 56 may, for example, employ a communication systems such as a local area network or the like. Alternatively, communication system 56 may utilize direct transfer of the game data files for a given game in a physical memory or storage medium loaded into the host game device via game data player 57.

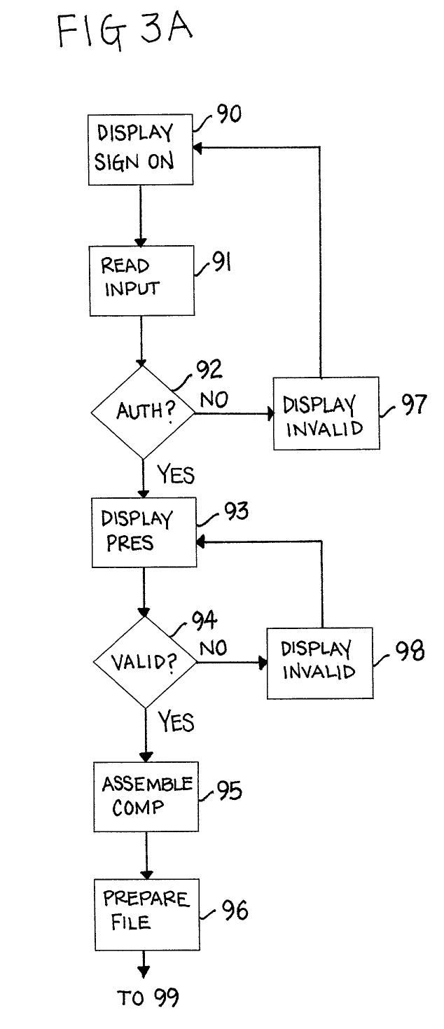

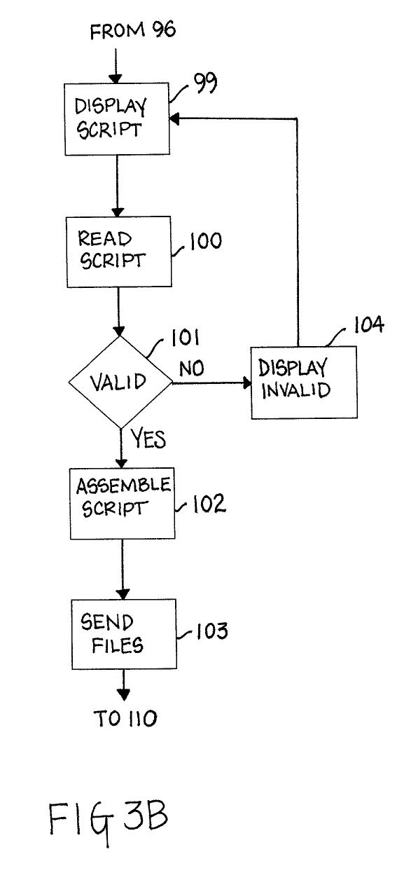

FIGS. 3A and 3B taken together set forth a flow diagram of the operation of the authoring system of the present invention method and apparatus. More specifically, the authoring system of the present invention method and apparatus initiates design activity by presenting a plurality of sign-on options to the game designer at step 90. The game designer responds to the options at step 90 by inputting selections in response to the options provided. At step 91, the system reads the game designer sign-on input which includes the examination of a designer identification code or number. At step 92, a determination is made as to whether the designer attempting to sign-on to the system is an authorized designer. If not, the system moves to a step 97 displaying an indication of invalid input and, thereafter, returns to step 90. If however, an authorized designer is identified at step 92, the system moves to a step 93 in which a plurality of presentation options are sequentially and interactively presented to the designer. In response to the presentation at step 93, the designer selects from the available presentation options. At step 94, a determination is made as to whether the combination of options created by selections at step 93 is a valid executable combination. If not, the system moves to a step 98 and displays an invalid input indication thereafter returning to step 93 and presenting a further options set to the designer. If however the combination at step 94 is valid, the system moves to a step 95 at which the selected options and the components which they require are assembled. The assembly of components is carried forward utilizing elements set forth in FIG. 2 which include presentation utility library 60, presentation library 61, audio library 63, video library 64 and graphics library 65. Once the selected components are assembled at step 95, the system moves to step 96 in which the game design file is prepared. During this activity, the elements set forth in FIG. 2 utilized include logic formulator 51 and game presentation generator 52. Once the game design file has been prepared at step 96, the system moves to step 99 shown in FIG. 3B.

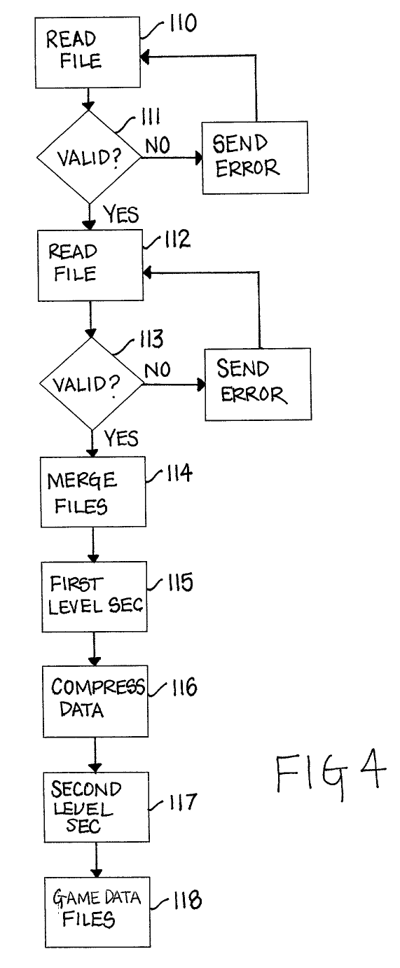

At step 99 shown in FIG. 3B, a sequence of script options are presented to the game designer. The game designer inputs script options which are read at step 100 by the system. A determination is made at step 101 as to whether the script options selected represent a valid combination of options and valid data. If valid data is not indicated, the system moves to a step 104 displaying an invalid data message and thereafter returns to step 99. If however, valid data is determined at step 101, the system moves to step 102 at which point the game script is assembled. The assembly of the game script is carried forward utilizing the elements provided in the collection of templates 70, choreographies 71, math algorithms 72, math tables 73, script library 74, logic routines 75 and script utility library 76 all shown in FIG. 2. With the assembled script, the system then moves to a step 103 in which the game design file prepared at step 96 (seen in FIG. 3A) together with the assembled script are transferred to collector 54 (seen in FIG. 2). The operation of collector 54 is shown in the flow diagram of FIG. 4 commencing with collector step 110.

Thus, as set forth in the operation shown in FIGS. 3A and 3B, the authoring system of the present invention method and apparatus utilizes an interactive presentation and selection together with menu driven elements to solicit a plurality of option selections and element choices by the game designer to prepare a game design file and a script which together are collected within the system compiler. It will be apparent to those skilled in the art that a substantial advantage is provided in the operation of the present invention authoring system in that the game designer may focus upon creative and artistic activities and need not be encumbered by the need for substantial or even significant computer or computer programming experience. In addition, the authorizing system will be understood to operate in accordance with the established limitations of approvable game and script elements to ensure that the designed game is readily approvable by game regulators.

FIG. 4 sets forth a flow diagram of the operation of collector 54 (seen in FIG. 2) and in general shows conversion of the game design and script files to form game data files used in operating the game data player within a host game machine such as a slot machine or the like. At step 110, the collector initiates action by reading the game design files. At step 111, a determination is made as to whether the game design file is valid. If not, the system moves to a step 119 in which an error message is displayed and the system returns to step 110. If however, valid game design files have been presented at step 111, the system moves to a step 112 in which it reads the script file. At step 113, a determination is made as to whether the script file is valid and if not valid the system moves to a step 120 in which an error message is displayed and the system returns to a step 112. If however at step 113 the script file is determined to be valid, the system moves to a step 114 in which the files are merged into instructions and data files. At step 115, the first level security features are added to the merged files after which at step 116 a data compression is applied. The data compression algorithm at step 116 may comprise any one of a number of well known compression algorithms as desired. Thereafter, at step 117, the second level security features are added to the compressed data files to form game data files 118. The resulting game data files at step 118 may then be transferred to a portable memory for installation in a gaming device and/or communicated by other communications apparatus such as a local area network or the like.

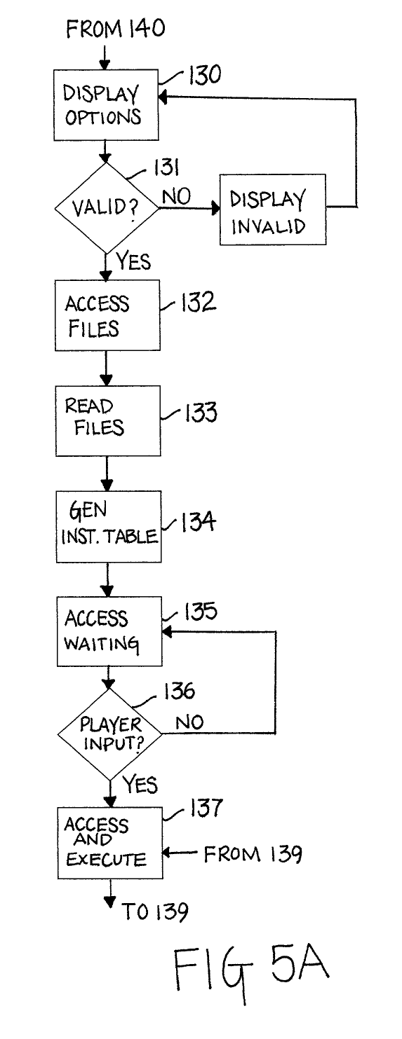

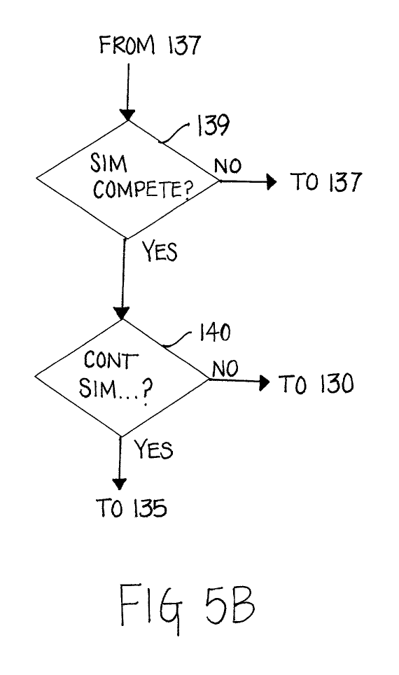

FIGS. 5A and 5B taken together set forth the flow diagram of operation for simulator 77 (seen in FIG. 2). By way of overview, the basic function of the simulator is to provide the game designer with the ability to view the operation of the game in its completed or partial form upon the display of the authoring computer system. It will be called that the game simulator is operated in response to the completed game data files. Accordingly, the simulator operates in a complete “closed loop” operation. This aspect of the simulator operation is extremely advantageous in that the game designer views the game play which results from the actual final collected and data compressed game data files. In effect, the simulator allows the game designer to see the same game presentation as would be viewed upon a host gaming device.

With specific reference to FIG. 5A, the simulator initiates operation at a step 130 in which a plurality of options are presented to the game designer. In response to the game designers option selection, the system moves to a step 131 at which the validity of options selected is reviewed. In the event the selected options are not valid, the system moves to a step 138 and displays an invalid data indication. Thereafter, the system returns to step 130. If however, the options selected are viewed as valid, the system moves to a step 132 in which the machine type structure files are accessed. Thereafter, the system moves to a step 133 reading the game data files. At step 134, the system responds to steps 132 and 133 and generates an instruction table. The instruction table comprises a sequential series of commands which are to be executed by the simulator and the authoring computer to provide simulation of game play. At step 135, the system accesses and executes a wait for input instruction. In response to a player input at step 136, the system moves to step 137 and accesses and executes the next instruction. Thereafter, the system moves to a step 139 shown in FIG. 3B. At step 139, a determination is made as to whether the execution at step 137 completed the game simulation. In the event game simulation is not complete, the system returns to step 137 to access and execute the next instruction. This process continues until the game simulation is determined at step 139 to be complete. Thereafter, the system moves to a step 140 in which a response is solicited from the user as to whether the simulation is to continue. If the game designer elects not to continue the simulation, the system returns to step 130 shown in FIG. 5A. If however simulation is to continue, the system returns to step 135 also shown in FIG. 5A and awaits the next input instruction.

FIGS. 6A and 6B taken together set forth the flow diagram of the operation of the game data player of the present invention method and apparatus. It will be recalled that the game data player of the present invention system resides within the host gaming device such as a slot machine or the like. It will be further recalled that the game data player in cooperation with the game data collector used in authoring system provides for the broad compatibility between each game data authored game and each game data player equipped gaming device.

With reference to FIG. 6A, the operation of the game data player is initiated by communication at step 150 of the game data files to the game data player. Thereafter, at step 151, the game data player reads the input game data files. It will be recalled that the game data files are in compressed data form and support one or more headers utilized in security and validation. At step 152, the player reads the first level security features from the compressed data files. Security features such as check sum and the like are employed in the game data file header to ensure that the files have not been altered. Once the first level security features have been examined, the system determines at step 153 whether the security remains intact. If security has been violated, the system moves to a step 157 in which an invalid data display is presented. Thereafter, the system further moves at step 158 to notify appropriate security staff of the violation of data security afterwhich the system either reboots or loads another game.

If however the security remains intact, the system moves to step 154 at which the files are decompressed. Following the decompression at step 154, the system moves to a step 155 at which the second level security features are read. These second level security features include additional security codes which may, for example, include the identifier of the regulator which approved the game together with validity of game unit operation at the resident property or casino as well as a jurisdiction identifier and approval of the host gaming device. The validation may also include additional anti-tampering codes. At step 156, a determination is made as to whether the second level security features remain intact and whether the regulators ID is valid. If not, the system returns to step 157 and displays an invalid data indication after which security is notified at step 158. If however security remains intact at step 156, the system moves to step 159 shown in FIG. 6B.

In accordance with an important advantage of the present invention method and apparatus, the game data files and game data player (seen in FIG. 2) function at an interpretive code level. Thus, the fabrication of the game data by the game designer using the authoring system provides interpretive instructions which the game data player uses to make functional calls or instructions to the host gaming device. The interpretive language calls or instructions cannot cause the gaming device to alter any of the critical game data or game results. In this manner, the integrity of the gaming device is maintained. For example, the game data player (game data player 57 in FIG. 2) can provide a call or instruction such as “print ticket”. It cannot, however, determine the payout amount on the ticket. That determination remains inaccessible to the game data player and game integrity is maintained. By way of further example, the game data player may call or instruct a random number generation but not determine the number. It may call a reel spin routine but not the resulting stopped position and so on.

With attention to FIG. 6B, at step 159 the system reads the regulator key which, as mentioned, is a unique code indicating game authority approval. At step 160, a determination is made as to whether the regulator key is valid. If not, the system returns to step 157 shown in FIG. 6A. If however the regulator key is valid, the system moves to a step 161 at which an instruction table is generated. The instruction table generated at step 161 comprises a sequence of game commands or directions which provide game play steps allowing the gaming device to operate under the complete control of the game data player. It will be noted that the complete control of the host gaming device by the game data player is a significant portion of the flexible compatibility between all game data authored games and all game data player equipped gaming devices.

Following the generation of the instruction table at step 161, the system moves to an idle state at step 162. In this idle state, the system is event driven and is waiting for an event such as a game play command. At step 163, the system determines whether an input such as a coin or token or other currency having been loaded into the host gaming device has been received. If not, the system remains idle until such input is received. Game security, communications, changing random number seeds, and other housekeeping functions occur in the background even during the idle state. Thereafter, in response to the game play input, the system moves to a step 164 at which the next instruction from the instruction table is read. At step 165, a determination is made as to whether the system is ready for the next command as set forth in the instruction read at step 164. Once the determination is made that the system is ready for the next command at step 165, the system moves to step 166 and sends the next command to the control apparatus of the host gaming device. A determination is made at step 167 as to whether the command at step 166 has been executed. The system does not proceed until a determination is made that the command has been executed. Once the command execution is complete, the system moves to a step 168 at which point a determination is made as to whether the entire game is complete. If the game is complete, the system returns to step 162 and awaits the next game player initiation of game play. If however the game is not complete, the system returns to step 165 and again waits unit the system is ready for the next command.

The cycle of operation between steps 165 through 168 continues as each successive command from the assembled instruction table generated at step 161 is executed by the gaming device in response to the game data player. Once the game is completely played, the system returns to step 162.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A gaming apparatus comprising:
a gaming device having game playing means;
a game data player coupled to said gaming device;
a game data collector forming a plurality of game data files defining a game; and
an authoring system responsive to game designer inputs to form game data files used by said game data collector in forming said plurality of game data files, said game data files being transferred from said game data collector to said game data player and said game data player producing a set of instruction commands from said game data files for causing said gaming device to play said game.

2. The gaming apparatus set forth in claim 1 wherein said gaming device is a slot machine.

3. The gaming apparatus set forth in claim 2 wherein said authoring system includes:
a set of game authoring software tools executable on a personal computer;
a plurality of game scripts selectable by inputs to said computer; and
a game simulator coupled to said game data collector for causing said personal computer to simulate play of said game.

4. The gaming apparatus set forth in claim 3 wherein said game data collector includes means for adding a first level security code to said game data files and wherein said game data player includes means for validating said data files in response to said first level security code.

5. The gaming apparatus set forth in claim 4 wherein said game data collector includes data compression means compressing said first level security code and said data files and wherein said game data player includes decompression means for decompressing said first level security code and said game data files.

6. The gaming apparatus set forth in claim 5 wherein said game data collector includes means for adding a second level security code following data compression and wherein said game data player includes means for validating said second level security code prior to decompression.

7. A gaming apparatus comprising:
a game authoring system forming game design files defining an game;
a game data collector coupled to said authoring system compiling said game design files into game data files;
a gaming device; and
a game data player coupled to and controlling said gaming device, said game data player receiving said game data files and converting said data files to a set of commands operative upon said gaming device to play said game.

8. The gaming apparatus set forth in claim 7 wherein said gaming device is a slot machine.

9. The gaming apparatus set forth in claim 8 wherein said authoring system includes:
a set of game authoring software tools executable on a personal computer;
a plurality of game scripts selectable by inputs to said computer; and
a game simulator coupled to said data collector for causing said personal computer to simulate play of said game.

10. The gaming apparatus set forth in claim 9 wherein said game data collector includes means for adding a first level security code to said game data files and wherein said game data player includes means for validating said game data files in response to said first level security code.

11. The gaming apparatus set forth in claim 10 wherein said game data collector includes data compression means compressing said first level security code and said game data files and wherein said game data player includes decompression means for decompressing said first level security code and said game data files.

12. The gaming apparatus set forth in claim 11 wherein said game data collector includes means for adding a second level security code following data compression and wherein said game data player includes means for validating said second level security code prior to decompression.

13. A method of producing game apparatus comprising the steps of:
designing a set of game files defining a game;
collecting said set of game files to form an ordered set of game data files;
transferring said set of game data files to a game data player;
forming an interpretive instruction table using said game data player in response to said game data files; and
operating a gaming device in response to said game data player using said instruction table to provide sequentially interpreted commands for said gaming device.

14. The method set forth in claim 13 wherein said collecting step includes the step of adding a first level security code and wherein said step of forming includes the step of reading and validating said first level security code.

15. The method set forth in claim 14 wherein said collecting step includes the step of data compression following said adding step and wherein said step of forming includes the step of data compression prior to said step of reading and validating.

16. The method set forth in claim 15 wherein said collecting step includes the step of inserting a second level security code after said step of data compression and wherein said step of forming includes the step of verifying said second level security code prior to said step of data compression.

17. The method set forth in claim 13 further including the step of simulating game play following said collecting step.

18. A method of producing game apparatus comprising the steps of:
designing a plurality of game design file sets each defining one of a plurality of games;
collecting each of said sets of game design files to form an ordered plurality of game data file sets;
providing a gaming device;
providing a game data player coupled to said gaming device;
forming an instruction table for interpretation, using said game data player in response to a selected one of said game data file sets; and
operating said gaming device under interpretive control of said game data player using said instruction table for interpretation to provide sequentially interpreted commands for said gaming device to play the game corresponding to said selected one of said game data file sets,
said game data player and said plurality of game data file sets being compatible such that each of said game data file sets may be used by said game data player to play the games corresponding thereto.

19. The method set forth in claim 18 wherein said collecting steps includes the step of adding a first level security code and wherein said step of forming includes the step of reading and validating said first level security code.

20. The method set forth in claim 19 wherein said collecting step includes the step of data compression following said adding step and wherein said step of forming includes the step of data compression prior to said step of reading and validating.

21. The method set forth in claim 20 wherein said collecting step includes the step of inserting a second level security code after said step of data compression and wherein said step of forming includes the step of verifying said second level security code prior to said step of data compression.

22. The method set forth in claim 18 further including the step of simulating game play following said collecting step.

23. The method set forth in claim 13 wherein said collecting step includes the steps of:
tokenizing said game data files by preprocessing said game files; and
parsing said game data files into tokens.
